(19) United States
(12) Patent Application Publication
(10) Pub. No.: US 2005/0275614 A1
(43) Pub. Date: Dec. 15, 2005

(54) Gate driving portion and display device having the same

(76) Inventors: Sung-Man Kim, Seoul (KR); Byeong-Jae Ahn, Seoul (KR); Hyang-Shik Kong, Suwon-si (KR); Seung-Jae Kang, Suwon-si (KR)

Correspondence Address: CANTOR COLBURN, LLP, 55 GRIFFIN ROAD SOUTH, BLOOMFIELD, CT, 06002, US

(21) Appl. No.: 11/121,463

(22) Filed: May 4, 2005

(30) Foreign Application Priority Data
Jun. 10, 2004 (KR) 10-2004-0042573

(51) Int. Cl. G09G 3/36

(52) U.S. Cl. 345/100

(57) ABSTRACT

A gate driving portion comprises a plurality of stages. Each stage comprises a first driving portion and a second driving portion. The first driving portion generates first and second output signals according to first input signals, and the second driving portion is connected to the first driving portion and generates third and fourth output signals according to second input signals. The first and second output signals are a first carry output signal or a first gate output signal of a current stage, and the third and fourth output signals are a second carry output signal or a second gate output signal of a following stage. According to this configuration, each stage generates two or more gate output signals and the gate driving portion outputs the first and second gate output signals to corresponding gate lines. Accordingly, the present invention can reduce the area of the gate driving portion and provide a high resolution of LCD device.

### BACKGROUND OF THE INVENTION

1. Field of the Invention

The present invention relates to a gate driving portion and a display device having the gate driving portion, and more particularly, to a display device having a gate driving device formed on a substrate and generating two or more gate output signals.

2. Description of the Related Art

Recently, flat display devices, for example, organic light emitting display (OLED), plasma display panel (PDP), liquid crystal display (LCD) devices are developing more rapidly than cathode ray tube (CRT) devices. Among the flat display devices, the LCD and OLED devices include a substrate in which pixels are formed. The pixels include switching elements, display signal lines, and a gate driving portion to generate gate control signals for turning the switching elements on and off. The gate driving portion includes a shift register receptive to outputting gate control signals to gate lines.

The shift register includes multiple stages, which are connected one after another to each other. Each stage includes a number of having transistors associated therewith. Each stage includes an input portion, an output portion, and a discharging portion. Each stage outputs gate signals to a gate line in accordance with clock signals or output signals of previous and next stages. In other words, each stage outputs gate output signals via the output portion to two different stages (e.g., previous and next stages).

The output portion of each stage includes transistors connected to a gate line and the input portions of the previous and next stages. A transistor in an output portion of each stage occupies about 40% of the total area of each stage because the transistor is much larger than other transistors associated with outputting the output signals to the gate lines and the previous stage. Accordingly, the dominating size of the transistor associated with the output portion of each stage mandates the size of the stages and hence the shift register, thus reduces flexibility of design margins of each stage.

### SUMMARY OF THE INVENTION

The present invention provides a gate driving portion having a plurality of stages.

In one embodiment, a gate driving portion includes a plurality of stages and each stage comprises a first driving portion generating first and second output signals according to first input signals, and a second driving portion connected to the first driving portion through a first clock signal terminal and generating third and fourth output signals according to second input signals, wherein the first and second input signals include two or more output signals of the adjacent stages, a second clock signal or at least one low-level signal, and the first, second, third, and fourth output signals include two or more gate output signals or two or more carry output signals.

The first and second clock signals have about a 180° phase difference. The at least one low-level signal is a Voff voltage or a reset voltage. The first driving portion generates gate output signals of odd gate lines and the second driving portion generates gate output signals of even gate lines. The first input signals in a first stage of the stages further include a vertical synchronization start signal (STV).

The first and second driving portions each includes an input portion to receive the first and second clock signals, the low-level voltage, and a carry output signal of the following stage generating first control signals; a pull-down driving portion connected to the input portion generating second control signals according to the first control signals from the input portion, the low-level voltage, a reset signal, and the gate output signal of the following stage; a pull-up driving portion connected to the input portion and the pull-down driving portion generating third control signals according to the first and second control signals, a carry output signal of the following stage and the first clock signal, and an output portion connected to the input portion and the pull-down and pull-up driving portions generating the first and second output signals according to the first clock signal and the first, second, and third control signals. The first and second driving portions have a mirror symmetric structure with respect to the first clock terminal.

The input portion comprises first, second, and third switching elements having the gates of the second and third switching elements connected to the second clock signal, the gate of the second switching element connected the first clock signal, and the first and second switching elements connected to the carry output signal of the previous stage and the low-level voltage, respectively.

The pull-up driving portion comprises a fifth switching element having a gate and a source connected to the carry output signal of the previous stage and a drain connected to a first contact point; a sixth switching element having a gate connected to the carry output signal of the following stage, a drain connected to the first contact point and a source connected to the pull-down driving portion and the output portion; an eighth switching element having a gate and a source connected to the first clock signal and a drain connected to a third contact point and the pull-down driving portion, and a ninth switching element having a gate and a source connected to a sixth contact point through a second capacitor, and the gate and a drain connected to a fourth contact point through a third capacitor, wherein the drain of the eighth switching element is connected to the gate of the ninth switching element.

The pull-down driving portion comprises a fourth switching element having a gate connected to the reset signal, a source connected to the carry output signal of the previous stage, and a drain connected to the low-level voltage; a seventh switching element having a gate connected to the gate output signal of the following stage, a drain connected to the low-level voltage, and a source connected to a fifth contact point; a tenth switching element having a gate connected to a second contact point, a drain connected to the low-level voltage, and a source connected to the third contact point; an eleventh switching element having a gate connected to the second contact point, a drain connected to the low-level voltage, and a source connected to the fourth contact point; a twelfth switching element having a gate connected to the fourth contact point, a drain connected to the low-level voltage, and a source connected to the second contact point; a thirteenth switching element having a gate connected to the gate output signal of the following stage, a drain connected to the low-level voltage, and a source connected to the second contact point; and a sixteenth switching element having a gate connected to the gate output signal of the following stage, a drain connected to the low-level voltage, and a source connected to the output portion.

The output portion comprises a fourteenth switching element having a gate connected to the fifth contact point, a drain connected to the second contact point, and a source connected to a first output terminal, and a fifteenth switching element having a gate connected to the gate of the fourteenth switching element and the fifth contact point, a drain connected to a second output terminal, and a source connected to the first clock signal.

The second driving portion further comprises an output assistance portion, the output assistance portion generates fourth control signals according to the third control signals and the first clock signal and controls the output portions of the first and second driving portions. The pull-down driving portion includes a seventeenth switching element having a gate connected to the gate output signal of the following stage, a drain connected to the fifth contact point, and a source connected to the low-level voltage. An eighteenth switching element has a gate connected to the gate output signal of the following stage, a drain connected to the second contact point, and a source connected to the low-level voltage.

The output assistance portion comprises a nineteenth switching element having a gate connected to the first contact point, a drain connected to the second contact point and the output portion of the second driving portion. The gate and drain of the nineteenth switching element are connected to each other through a first capacitors and a source connected to the first clock signal. The first contact point maintains a high voltage during 4 H. The fifth contact point maintains a high voltage during 2 H. The fifth contact point of the second driving portion changes a low voltage into a high voltage when the gate output signal of the following stage is generated, and maintains the high voltage during 2 H. The reset signal is generated at a dummy stage after about half of stages and is inputted to all the stages. The first capacitor has a voltage higher than a high voltage. The first to nineteenth switching elements are made of amorphous silicon. The first to nineteenth switching elements are formed by a substantially same manufacturing process as switching elements of the pixel area.

In another embodiment, a gate driving portion includes a plurality of stages, each stage comprises a first gate line having a first connecting member; a first insulating layer formed on the first connecting member; a first conductive layer formed on the first insulating layer; a second insulating layer formed on the first insulating layer and the first conductive layer; a first connecting assistance member connected to the first conductive layer and the first connecting member; a second gate line having a second connecting member disposed between the first connecting member and the first conductive layer, the first insulating layer formed on the second connecting member; a second conductive layer formed on the first insulating layer, the second insulting layer formed on the first insulating layer and the second conductive layer; and a second connecting assistance member connected to the second conductive layer and the second connecting member.

In another embodiment, a display device comprises a signal controller receiving image data signals and control signals generating gate and data control signals; a data driving portion receiving the image data signals and the data control signals and converting the image data signals into image data voltages according to the data control signals; a gate driving portion generating gate output signals turning on or turning off the switching elements according to the gate control signals; and a TFT array panel having data lines, gate lines, switching elements, and pixel circuits on an insulating substrate, wherein the gate driving portion is formed on the insulating substrate and includes stages corresponding to the gate lines, each stage generates two or more gate output signals.

These and other objects, features, and advantages of the present invention will become apparent from the following detailed description of embodiments thereof, which is to be read in connection with the accompanying drawings.

This application relies for priority upon Korean Patent Application No. 2004-0042573 filed on Jun. 10, 2004, the contents of which are herein incorporated by reference in its entirety.

### BRIEF DESCRIPTION OF THE DRAWINGS

The above and other features and advantage points of the present invention will become more apparent by describing in detailed embodiments thereof with reference to the accompanying drawings, in which:

FIG. 1 is a block diagram of a display device according to an exemplary embodiment;

FIG. 2 is an equivalent circuit view of a pixel in the display device according to an exemplary embodiment;

FIG. 3 is a block diagram of a gate driving portion according to an exemplary embodiment;

FIG. 4 is a circuit diagram of the jth stage in a shift register for the gate driving portion in FIG. 3;

FIG. 5 is a graphical view of signal waveforms of the gate driving portion in FIG. 3;

FIG. 6a is a circuit diagram showing a part of the jth stage in FIG. 4;

FIG. 6b is a circuit diagram showing a part of the jth stage according to another exemplary embodiment;

FIG. 7 is a diagram of a TFT array panel for the display device according to an exemplary embodiment;

FIG. 8 is a cross-sectional view of the TFT array panel taken along line 7-7 in FIG. 7;

FIG. 9 is a layout view of the gate line in FIG. 3; and

FIG. 10 is a cross-sectional view taken along line 9-9 in FIG. 9.

### DETAILED DESCRIPTION OF THE INVENTION

Hereinafter the embodiments of the present invention will be described in detail with reference to the accompanied drawings.

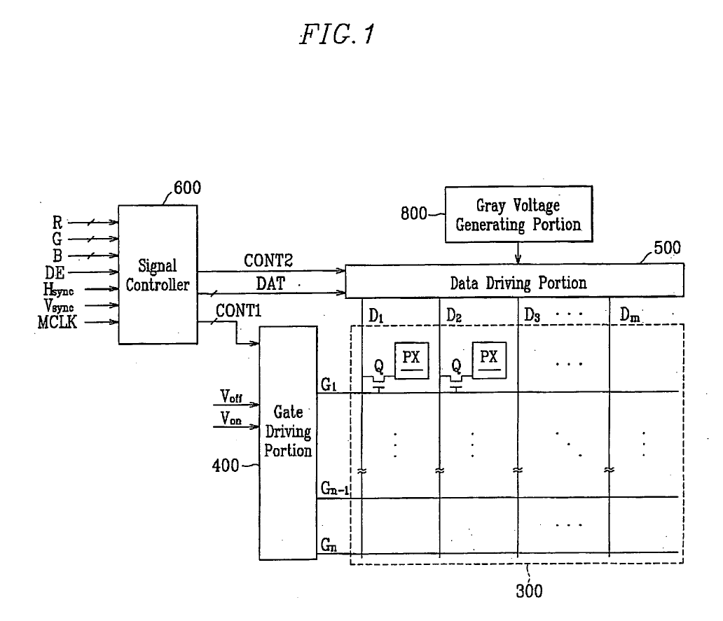

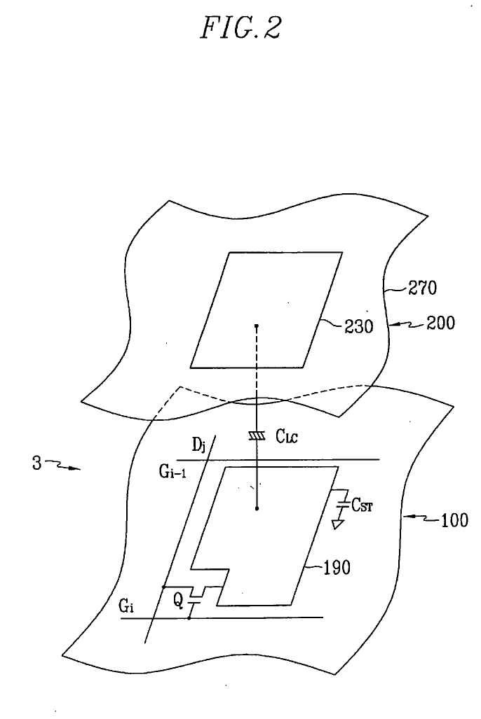

FIG. 1 is a block diagram of a display device according to an exemplary embodiment, and FIG. 2 is an equivalent circuit depicting a pixel in the display device according to an exemplary embodiment.

As shown in FIG. 1, a display device includes a thin film transistor (TFT) array panel 300. Gate and data driving portions 400 and 500, respectively, are connected to the TFT array panel 300. A gamma voltage generating portion 800 is connected to the data driving portion 500 and a signal controller 600.

The TFT array panel 300 includes signal lines (G1-Gn) extending to gate driving portion 400 and signal lines (D1-Dm) extending to data driving portion 500. The TFT array panel 300 also includes pixels Px each connected to the signal lines and arranged in a matrix. The signal lines (G1-Gn, D1-Dm) include gate lines G1-Gn delivering gate signals and data lines D1-Dm delivering data signals. The gate lines G1-Gn are formed parallel with each other in the horizontal direction and the data lines D1-Dm are formed parallel with each other intersecting the gate lines G1-Gn, as illustrated. Each pixel Px includes a switching element Q connected to the gate and data lines (G1-Gn, D1-Dm) and a pixel circuit (not shown) connected to the switching element Q. The switching element Q may be a thin film transistor. In addition, switching element Q may be fabricated with amorphous silicon.

In a liquid crystal display (hereinafter, referred to as “LCD”) device, as shown in FIG. 2, the TFT array panel 300 includes a lower substrate 100, an upper substrate 200, and a liquid crystal layer indicated generally at 3 disposed between the lower and upper substrates 100 and 200. The lower substrate 100 includes the gate and data lines (G1-Gn, D1-Dm) of FIG. 1 indicated as Gi−1 and Gi, and the switching elements Q (only one shown). The pixel circuits include liquid crystal capacitors C_{LC}_{_{—}}and storage capacitors C_{ST}. However, the storage capacitors C_{ST} may be omitted as required.

The liquid crystal capacitor C_{LC} has conductive layers of a pixel electrode 190 formed on the lower substrate 100. A common electrode 270 is formed on the upper substrate 200, and a dielectric layer (not shown) of the liquid crystal layer 3. The pixel electrode 190 is connected to the switching element Q. The common electrode 270 is formed on a whole surface defining the upper substrate 200 and receives a common voltage Vcom (not shown). However, the common electrode 270 may be formed on the lower substrate 100. When common electrode 270 is formed on the lower substrate 100, the pixel and common electrodes 190 and 270 may have a stick or a linear shape.

The storage capacitor C_{ST} is formed by overlapping another signal line (not shown) formed on the lower substrate 100 and the pixel electrode 190. The overlapped signal line receives a predetermined voltage, such as the common voltage Vcom described above with respect to common electrode 270 on the upper substrate 200. Further, the storage capacitor C_{ST} may be formed by overlapping the previous gate line and the pixel electrode 190.

The upper substrate 200 has color filters 230, including red, green, and blue filters, for example, for displaying images. As shown in FIG. 2, the color filters 230 are formed on the upper substrate 200, but the color filters 230 may be formed on or under the pixel electrode 190 formed on the lower substrate 100. At least one polarizer (not shown) is disposed exterior of the lower or upper substrates 100 and 200 for polarizing light.

Referring back to FIG. 1, the gamma voltage generating portion 800 has groups of positive voltages and negative voltages with respect to the common voltage. The gate driving portion 400 is connected to the gate lines G1-Gn and applies the gate control signals, such as a gate-on voltage Von and a gate-off voltage Voff, to the gate lines G1-Gn. The gate-on voltage Von turns on the switching element Q and the gate-off voltage Voff turns off the switching element Q. The data driving portion 500 is connected to the data lines D1-Dm, and applies the data voltages to the pixels (PX) by selecting the gamma voltages corresponding to a digital image data from the gamma voltage generating portion 800. The signal controller 600 controls operation of the gate and data driving portions 400 and 500, respectively.

Now, operation of the display device will be described in detail with reference to FIG. 1.

The signal controller 600, as best seen with reference to FIG. 1, receives image data signals R, G, B, and input control signals including a horizontal synchronization signal Hsync, a vertical synchronization signal Vsync, a main clock MCLK and a data enable signal DE, for example, from an external device (not shown). The signal controller 600 generates gate control signals CONT1 and data control signals CONT2 in accordance with the image data signals R, G, B, and the input control signals. The signal controller 600 sends the gate control signals CONT1 to the gate driving portion 400 and the data control signals CONT2 to the date driving portion 500.

The gate control signals CONT1 include a vertical synchronization start signal, a gate clock signal and an output enable signal, for example. The vertical synchronization start signal instructs the gate driving portion 400 to start the output of the gate-on voltage Von, the gate clock signal that controls the output of the gate-on voltage Von, and the output enable signal that controls the period of the gate-on voltage Von. The data control signals CONT2 include a horizontal synchronization start signal, a load signal, and a data clock signal, for example. The horizontal synchronization start signal informs the data driving portion 500 of the output period of image data voltages. The load signal instructs the data driving portion 500 to apply the image data voltages to the data lines D1-Dm. In this embodiment, the data control signals CONT2 may include a polarity inversing signal inversing the image data voltages with respect to the common voltage.

The data driving portion 500 sequentially receives image data signals corresponding to the pixels according to the data control signals CONT2 from the signal controller 600, and converts the image data signals into image data voltages by selecting the gamma voltages corresponding to the image data signals. Then, the data driving portion 500 applies the image data voltages to the data lines D1-Dm.

The gate driving portion 400 applies the gate-on voltage Von to the gate lines G1-Gn according to the gate control signals CONT1 from the signal controller 600, and turns on the switching elements Q connected to the gate lines G1-Gn. The image data voltages applied to the data lines D1-Dm are then applied to the corresponding pixels as the switching elements Q are turned on. As shown in FIG. 2, a voltage difference between the image data voltages and the common voltage Vcom represents a charging voltage, for example, a pixel voltage, in the liquid crystal capacitor C_{LC}.

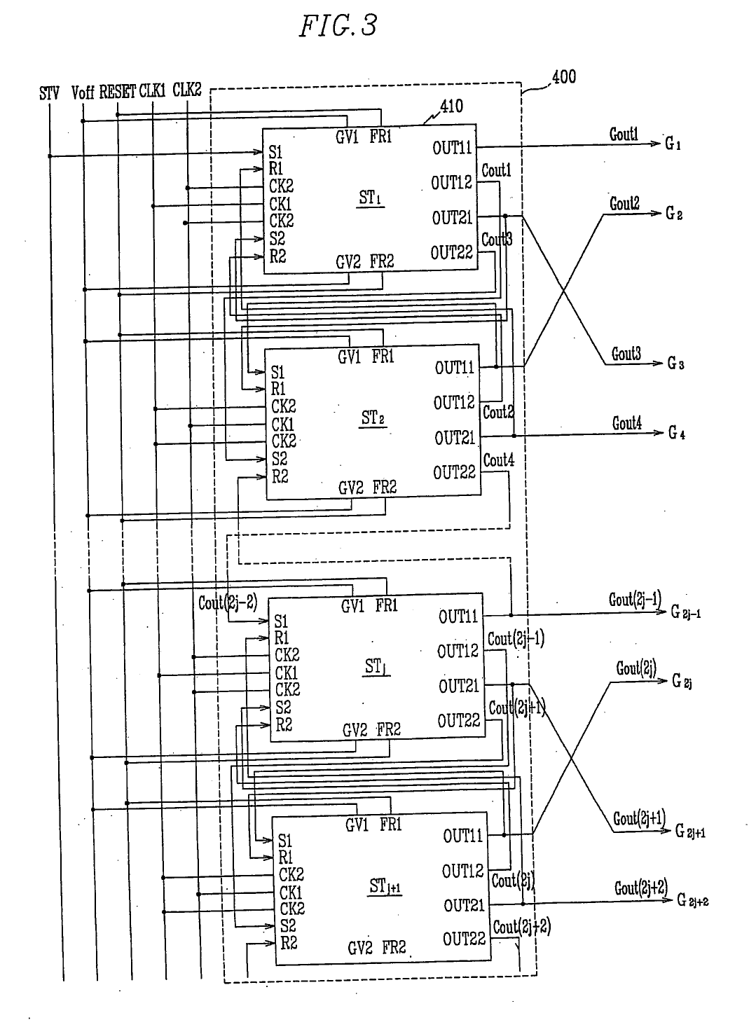

Now, the gate driving portion 400 according to an exemplary embodiment will be described in more detail with reference to FIGS. 3 to 10.

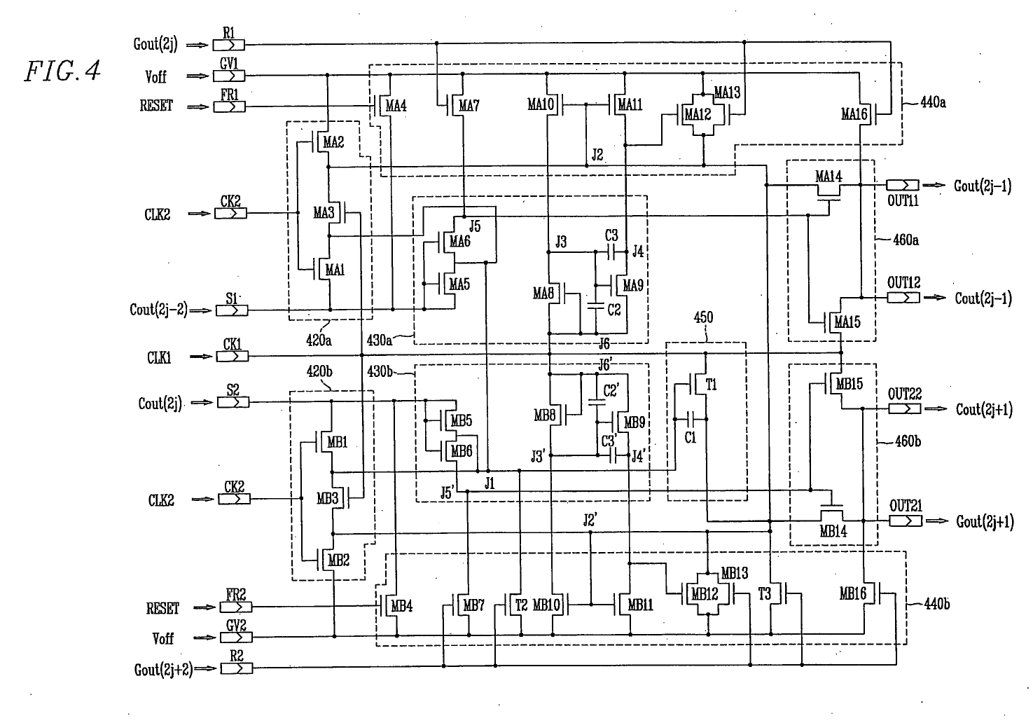

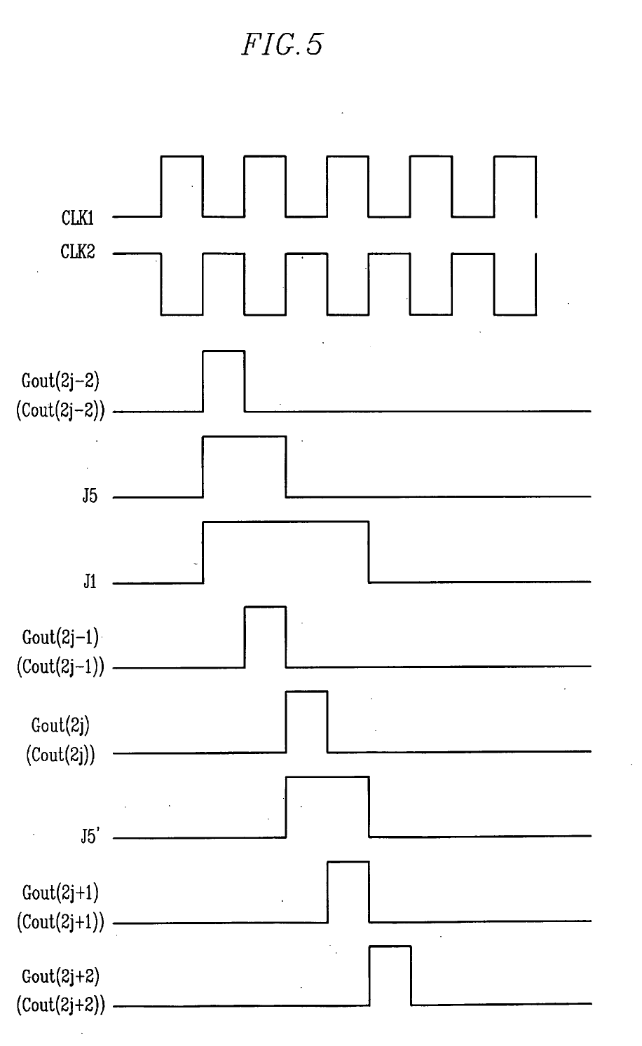

FIG. 3 is a block diagram of the gate driving portion 400, FIG. 4 is a circuit view of the jth stage of a shift register for the gate driving portion in FIG. 3, and FIG. 5 is a graphical view of signal waveforms of the gate driving portion in FIG. 3.

As shown in FIG. 3, the gate driving portion 400 includes a shift register having a plurality of stages 410 (only four shown). Each stage 410 is connected to two gate lines (e.g., Gₙ, Gₙ₊₁). The gate driving portion 400 receives a frame reset signal (RESET), a vertical synchronization start signal (STV), clock signals (CLK1) and (CLK2), and a gate-off voltage (Voff). For simplicity, a high level and a low level of the clock signals CLK1 and CLK2 designates a high voltage and a low voltage, respectively. The low voltage is the substantially same as Voff.

As described above, each stage 410 is connected to the two gate lines, wherein one of the two gate lines of each stage 410 and a gate line of an adjacent stage intersect. In other words, as shown in FIG. 3, gate lines G₂ and G₃ connected to first and second stages ST1 and ST2, respectively, of four gate lines G1-G4 connected to first and second stages ST1 and ST2 intersect. Additionally, two gate lines G₂ⱼ and G₂ⱼ₊₁ of gate lines G₂ⱼ₋₁-G₂ⱼ₊₂ connected to the jth stage STj and the (j+1) stage STj+1 (j is a odd number) intersect.

Each stage 410 includes set terminals S1 and S2, gate voltage terminals GV1 and GV2, clock terminals CK1 and CK2, reset terminals R1 and R2, frame reset terminals FR1 and FR2, gate output terminals OUT11 and OUT21, and carry output terminals OUT12 and OUT22.

The set terminal S1 of each stage, for example, the jth stage STj receives the carry output signal of a previous stage STj−1 (not shown), such as a previous carry output signal Cout (2j−2) and the reset terminal R1 receives the gate output of a following stage STj+1, such as a following gate output Gout (2j). Further, the set terminal S2 receives a following carry output signal Cout 2j and the reset terminal R2 receives a following gate output Gout 2j+2. Herein, the set terminals S1 and S2 of the first stage of two adjacent stages receive the carry output signals from the previous and following stages, respectively, but the set terminals S1 and S2 of the second stage of the two adjacent stages both receive a carry output signal from the previous stage. Meanwhile, the reset terminals R1 and R2 of the first stage of the two adjacent stages both receive gate outputs from the following stage and the reset terminals R1 and R2 of the second stage of the two adjacent stages receive gate outputs from the previous and following stages, respectively.

The clock terminals CK1 and CK2 of the jth stage STj receive the clock signals CLK1 and CLK2, respectively, and the gate voltage terminals GV1 and GV2 of the jth stage STj both receive the gate-off voltage Voff. The gate output terminals OUT11 and OUT21 output the gate output Gout 2j−1 and Gout 2j+1, respectively, and the carry output terminals OUT12 and OUT22 output the carry output signals Cout 2j−1 and Cout 2j+1, respectively. In the first stage ST1, the set terminal S1 receives the vertical synchronization start signal STV instead of the previous carry output. When the clock terminals CK1 and CK2 of the jth stage STj receives the clock signals CLK1 and CK2, respectively, the clock terminal CK1 of the adjacent (j−1)th and (j+1)th stage STj−1 and STj+1 receives the clock signal CLK2 and the clock terminal CK2 of the adjacent (j−1)th and (j+1)th stage STj−1 and STj+1 receives the clock signal CLK1.

When the clock signals CLK1 and CLK2 are at a high voltage, the high voltage is substantially the same as the gate-on voltage Von. Further, when the clock signals CLK1 and CLK2 are at a low voltage, the low voltage is the same as the gate-off voltage Voff. As shown in FIG. 5, the clock signals CLK1 and CLK2 have a duty ratio of 50% (e.g., clock is on for the same duty cycle that it is off) and phase difference of the clock signals CLK1 and CLK2 is 180°.

Referring to FIG. 4, the STj stage or jth stage 410 of FIG. 3 is illustrated. Each stage 410, including the jth stage of FIG. 4, of the gate driving portion 400 has a mirror symmetric structure with respect to the clock line connected to the clock terminal CK1. Each stage 410 includes input portions 420a and 420b, pull-up driving portions 430a and 430b, pull-down driving portions 440a and 440b, output assistance portion 450, and output portions 460a and 460b. The input portions 420a and 420b, pull-up driving portions 430a and 430b, pull-down driving portions 440a and 440b, output assistance portion 450, and output portions 460a and 460b include NMOS transistors MA1-MA15, MB1-MB15 and T1-T3. The pull-up driving portions 430a and 430b further include capacitors C2, C3, C2′ and C3′. The output assistance portion 450 further includes a capacitor C1. Alternatively, PMOS transistors may be used instead of the NMOS transistors, and the capacitors C1-C3, C2′, and C3′ may be parasitic capacitances between a gate electrode and a drain electrode, and the gate electrode and a source electrode.

The input portion 420a includes three transistors MA1, MA2 and MA3 connected to the set terminal S1 and the gate voltage terminal GV1. The input portion 420b includes three transistors MB1, MB2 and MB3 connected to the set terminal S2 and the gate voltage terminal GV2. The gates of the transistors MA1-MA2 and MB1-MB2 are connected to the clock terminal CK2. The gates of the transistors MA3 and MB3 are connected to the clock terminal CK1. Contact points of the transistors MA1 and MA3 and the transistors MB1 and MB3 are commonly connected to a contact point J1. A contact point of the transistors MA3 and MA2 is connected to a contact point J2, and a contact point of the transistors MB3 and MB2 is connected to a contact point J2′.

The pull-up driving portion 430a includes two transistors MA5 and MA6 disposed between the set terminal S1 and a contact point J5, a transistor MA8 disposed between the clock terminal CK1 and a contact point J3, and a transistor MA9 disposed between the clock terminal CK1 and a contact point J4. The gates of the transistors MA5 and MA6 are connected to the set terminal S1, and the drain of the transistor MA5 is connected to the gate of transistor MA5. A contact point of the transistors MA5 and MA6 is connected to the contact point J1; the gate and drain of the transistor MA8 are connected to the clock terminal CK1; and the source of the transistor MA8 is connected to the contact point J3. The gate of the transistor MA9 is connected to the contact point J3, and the clock terminal CK1 through a capacitor C2. The drain of the transistor MA9 is connected to the clock terminal CK1; the source of the transistor MA9 is connected to the contact point J4 and a capacitor C3 is disposed between the contact points J3 and J4.

The pull-up driving portion 430b includes two transistors MB5 and MB6 disposed between the set terminal S2 and a contact point J5′, a transistor MB8 disposed between the clock terminal CK1 and a contact point J3′, and a transistor MB9 disposed between the clock terminal CK1 and a contact point J4′. The gates of the transistors MB5 and MB6 are connected to the set terminal S2, and the drain of the transistor MB5 is connected to the gate. A contact point of the transistors MB5 and MB6 are connected to the contact point J1, and the gate and drain of the transistor MB8 are connected to the clock terminal CK1, and the source of the transistor MB8 is connected to the contact point J3′. The gate of the transistor MB9 is connected to the clock terminal CK1 through a capacitor C2′. The drain of the transistor MB9 is connected to the clock terminal CK1; the source of the transistor MB9 is connected to the contact point J4′, and a capacitor C3′ is disposed between the contact points J3′ and J4′.

The pull-down driving portion 440a includes transistors MA4, MA7, MA10, MA11, MA12, MA13, MA16. The pull-down driving portion 440b includes transistors MB4, MB7, MB10, MB11, MB12, MB13 and MB16. The pull-down driving portions 440a and 440b further include two transistors T2 and T3. The gates of the transistors MA4 and MB4 are connected to the frame reset terminals FR1 and FR2, respectively, while the drains of the transistors MA4 and MB4 are connected to the set terminals S1 and S2, respectively. The gates of the transistors MA7 and MB7 are connected to the reset terminals R1 and R2, respectively, and the drains of the transistors MA7 and MB7 are connected to the contact points J5 and J5′, respectively. The gates of the transistors MA10, MA11 and transistors MB10, MB11 are connected to the contact points J2 and J2′, respectively. The drains of the transistors MA10 and MA11 are connected to the contact points J3 and J4, respectively, while the drains of the transistors MB10 and MB11 are connected to the contact points J3′ and J4′, respectively. The gates of the transistors MA12 and MB12 are connected to the contact points J4 and J4′, respectively, while the gates of the transistors MA13 and MB13′ are connected to the reset terminals R1 and R2, respectively. The drains of the transistors MA12 and MA13 and the transistors MB12 and MB13 are connected to the contact points J2 and J2′, respectively. The gates of the transistors MA16 and MB16 are connected to the reset terminals R1 and R2, respectively; the drain of the transistor MA16 is connected to the output terminals OUT11 and OUT12, and the drain of the transistor MB16 is connected to the output terminals OUT21 and OUT22. The gates of the transistors T2 and T3 are connected to the reset terminal R2, and the drains of the transistors T2 and T3 are connected to the contact points J1 and J2′, respectively. Herein, it should be noted that the contact points J2 and J2′ are connected to each other.

The output assistance portion 450 includes a transistor T1 and a capacitor C1. The drain and source of the transistor T1 are connected to the contact points J2 and J2′, respectively, and the capacitor C1 is disposed between the gate and source of the transistor T1.

The output portion 460a includes transistors MA14 and MA15 and the output portion 460b includes transistors MB14 and MB15. The gates of the transistors MA14 and MA15 and the transistors MB14 and MB15 are connected to the contact points J5 and J5′, respectively, and the drains of the transistors MA14 and MB14 are connected to the contact points J2 and J2′, respectively.

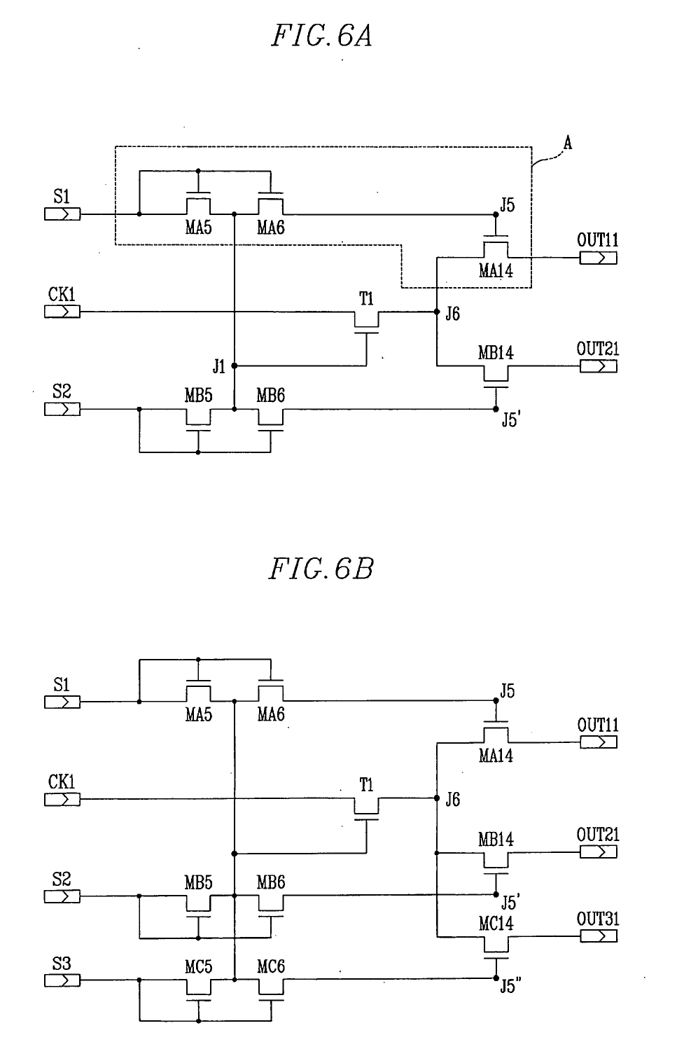

Now, operation of the stage in the shift register will be described in detail with reference to FIG. 5 in conjunction with FIG. 6.

FIG. 5 is a graphical view of the signal waveforms of the gate driving portion in FIG. 3.

When the clock signal CLK2 and the previous carry output Cout (2j−2) are at a high voltage and the clock signal CLK1 is at a low voltage, the transistors MA1, MA2, MA5 and MA6 are turned on. The transistors MA5 and MA6 deliver the high voltage to the contact points J1 and J5, and the transistor MA2 delivers a low voltage to the contact point J2. The transistors T1, MA14 and MA15 are turned on, and then the low voltage at the contact point J2 and the clock signal CLK1 are output to the output terminals OUT11 and OUT12, respectively. In other words, the output voltages Gout (2j−1) and Cout (2j−1) become a low voltage. Further, the voltage difference between the high and low voltages is charged in the capacitor C1. At this time, since the clock signal CLK1, the following gate outputs Gout 2j, Gout (2j+1) and Gout (2j+2), and the contact point J2 are at a low voltage, the transistors MA3, MA4, MA7-MA13, MB3-MB13, T2 and T3 are turned off.

Next, when the clock signal CLK2 is at a low voltage and the clock signal CLK1 is at a high voltage, the transistors MA1, MA2, MB1 and MB2 are turned off and the output voltage of the transistor T1 and the contact point J2 become a high voltage. At this time, although the gates of the transistors MA3 and MB3 receive a high voltage, the transistors MA3 and MB3 are turned off because the sources of the transistors MA3 and MB3 also have the same voltages as the contact points J2 and J2′ and the voltage difference between the gate and the source becomes zero. Accordingly, the contact point J1 becomes a floating state, and thus has a voltage, for example, about two times as high as a high voltage, more than a high voltage by the capacitor C1.

Meanwhile, since the clock signal CLK1 and the contact points J2 and J2′ are at a high voltage, the transistors MA8, MA10, MA11, MB8, MB10 and MB11 are turned on. When the transistors MA8 and MA10 are turned on, the contact point J3 has a divided voltage by a resistor (not shown) disposed between the transistors MA8 and MA10 and the contact point J3′ has a divided voltage by a resistor (not shown) disposed between the transistors MB8 and MB10. However, when the resistor in a turn-on time of the transistors MA10 and MB10 is about 10,000 times as large as the resistor in a turn-on time of the transistors MA8 and MB8, the divided voltages have the substantially same voltages as the contact points J3 and J3′. At this time, the transistors MA9 and MB9 are turned on, and thus are serially connected to the transistors MA11 and MB11. Further, the contact point J4 has a divided voltage by a resistor (not shown) in a turn-on time of the transistors MA9 and MA11 and the contact point J4′ has a divided voltage by a resistor (not shown) in a turn-on time of the transistors MB9 and MB11. For example, if the resistor of the transistors MA9 and MA11 is the same as that of the transistors MB9 and MB11, the contact points J4 and J4′ have about half voltages of the high and low voltages. Accordingly, the transistors MA12 and MB12 maintain a turn-off state. Since a following gate output Gout 2j maintains a low voltage, the transistor MA7 maintains a turn-off state and the contact point J5 maintains a high voltage. Accordingly, the output terminals OUT11 and OUT12 are connected to the contact point J2 and output a high voltage.

Meanwhile, voltages corresponding to voltage differences across the capacitors C2 and C3 are charged in the capacitors C2 and C3, respectively, and the contact point J3 has a voltage lower than the contact point J6.

Next, when the following gate output Gout 2j and the clock signal CLK2 is at a high voltage and the clock signal CLK1 is at a low voltage, the transistors MA5 and MA13 are turned on and the low voltages are sent to the contact points J5 and J2, respectively. At this time, since transistors MA14 and MA15 are turned off and a transistor MA16 is turned on, the output terminals OUT11 and OUT12 are connected to the gate off voltage terminal Voff and low voltages are output.

Meanwhile, since the transistors MA8 and MA10 are turned off, the contact point J3 has a floating state. Further, since the contact point J3 has a voltage lower than the contact point J5 by the capacitor C2 even when the contact point J6 has a voltage lower than the contact point J4, the transistor MA9 is turned off. At this time, since the transistor MA11 is turned off and the contact point J4 has a low voltage, the transistor MA12 maintains a turn-off state. Further, the transistor MA3 maintains a turn-off state because the gate of the transistor MA3 has a low voltage and the contact point J2 has a low voltage. Since the contact point J1 has a high voltage, the transistor T1 maintains a turn-off state.

Next, when the clock signal CLK1 is at a high voltage, the transistors MA8 and MA10 are turned on and the contact point J4 has an increased voltage and thus the transistor MA12 is turned on and the contact point J2 has a low voltage. In other words, although the following gate output Gout 2j is at a low voltage, the contact point J2 may have a low voltage.

Meanwhile, the input portion 420b, the pull-up driving portion 430b, and the pull-down driving portion 440b operate substantially the same as the input portion 420a, the pull-up driving portion 430a, and the pull-down driving portion 440a described hereinabove. Thus, a detailed description of these operations will be omitted.

However, the contact point J1 has the voltage adding the voltage charged in the capacitor C1 to a high voltage. In other words, when the gate output Gout 2j is at a high voltage, the contact point J1 has a high voltage, and then when the clock signal CLK1 is at a high voltage, the contact point J1 has the voltage adding the voltage charged in the capacitor C1 to a high voltage. Referring to FIG. 5, the contact point J1 has a constant voltage, but may be increased by a voltage when the carry output signal Cout (2j−1) and Cout (2j+1) are generated. Meanwhile, the contact point J5′ has a high voltage when the carry output Cout 2j is at a high voltage, and the contact point J5′ has a floating state when the carry output Cout 2j is at a low voltage. Accordingly, the contact point J5′ maintains the high voltage. In other words, the contact point J5′ maintains the high voltage during 2 H or a full duty cycle.

When the gate output Gout (2j+2) is at a high voltage, the contact points J1 and J5′ has low voltages by a transistor MB7, respectively. Accordingly, the contact point J1 maintains a high voltage during 4 H or two duty cycles and the contact point J5′ maintains a high voltage during 2 H or a single duty cycle.

Meanwhile, when the gates of the transistors MA3 and MB3 are connected to the high voltage of the clock signal CLK1 and the contact points J2 and J2′ have a low voltage, the transistors MA3 and MB3 are turned on and the low voltage of the contact points J2 and J2′ is sent to the contact point J1. However, the drain of the transistor T1 is connected to the clock terminal CK1, and thus receives the clock signal CK1 continuously. More particularly, since the transistor T1 is much larger than other transistors, the parasitic capacitance between the gate and the drain of the transistor T1 is relatively large. Accordingly, when the clock signal CK1 is at a high voltage, the transistor M10 may be turned on by the parasitic capacitance. Maintaining the gate of the transistor T1 at a low voltage by delivering low voltages to the contact point J1 prevents the transistor T1 from being turned on.

Next, after operation of the n/2 stage of the n stage, the reset signal RESET generated at the following dummy stage is input to the frame reset terminals FR1 and FR2 of all of the stages and sets the set terminals S1 and S2 to a low voltage.

Then, until the previous carry output Cout (2j−2) becomes a high voltage, the contact point J1 maintains a low voltage. When the clock signal CLK1 is at a high voltage and the clock signal CLK2 is at a low voltage, the contact points J2 and J2′ have a low voltage by the transistors MA12 and MB12, and when the clock signal CLK1 is at a low voltage and the clock signal CLK2 is at a high voltage, the contact points J2 and J2′ maintain a low voltage by the transistors MA2 and MB2.

In this manner, the stage 410 generates the carry output signals Cout (2j−1) and Cout (2j+1) in accordance with the carry output signals Cout (2j−2) and Cout 2j and the gate output signals Gout 2j and Gout (2j+2) and by synchronizing with the clock signals CLK1 and CLK2.

As shown in FIG. 4, outputting two gate output signals in one stage has been described, but it is contemplated that two or more gate output signals may be generated in one stage. Now, a detailed description will be described in detail with reference to FIGS. 6a and 6b.

FIG. 6a is a circuit diagram showing a part of the jth stage of FIG. 4.

As described above, when the carry output signal input to the set terminal S1 is at a high voltage, the contact points J1 and J5 have a high voltage and thus the transistors T1 and MA14 are turned on. The high voltage is output while the clock signal CLK1 becomes a high voltage, which is output to outside. Further, when the carry output signal input to the set terminal S2 is at a high voltage, the contact points J1 and J5′ have a high voltage, and thus the transistors T1 and MB14 are turned on. The high voltage is output while the clock signal CLK1 becomes a high voltage. Accordingly, the contact point J4 maintains a high voltage during 4 H or two duty cycles and the contact points J5 and J5′ maintain a high voltage during 2 H or a single duty cycle.

As shown in FIG. 6b, when the configuration in an “A” region illustrated in FIG. 6A is applied, one output terminal may be further added to the configuration in FIG. 6a. Accordingly, output signals are output while the contact point J1 maintains a high voltage during 6 H or three duty cycles and the contact points J5, J5′ and J5″ maintain a high voltage during 2 H or a single duty cycle. In other words, when the configuration of FIG. 6B is applied repeatedly, it should be noted that two or more gate lines may be connected to one stage. According to this configuration, the number of the transistors corresponding to transistor T1 occupying the largest area of the stage may be reduced, and thus the whole area of the stage may be reduced. Further, the transistor T1 may be manufactured bigger than the conventional structure and the output performance may be also improved.

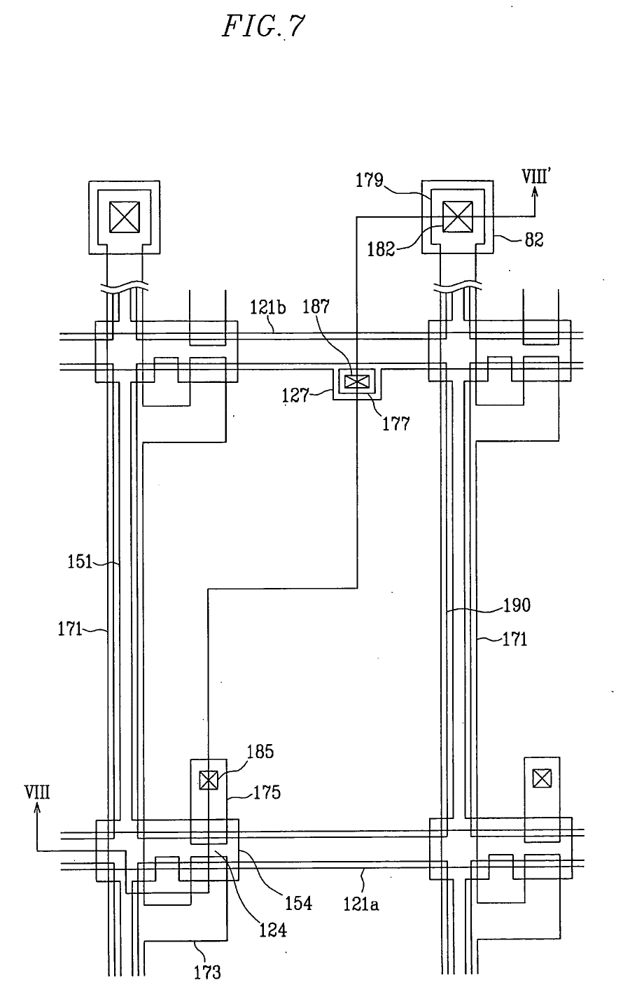

Now, the structure of a TFT array panel for a display device according to an embodiment will be described in detail with reference to FIGS. 7 to 10.

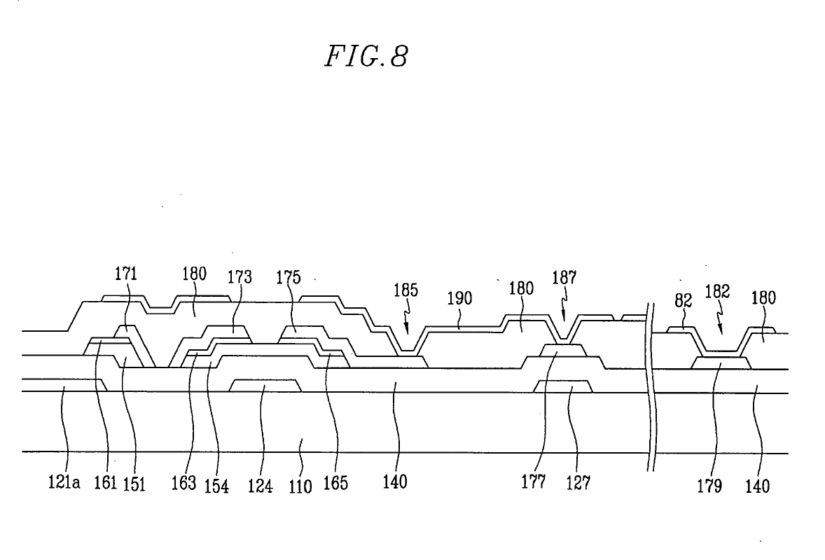

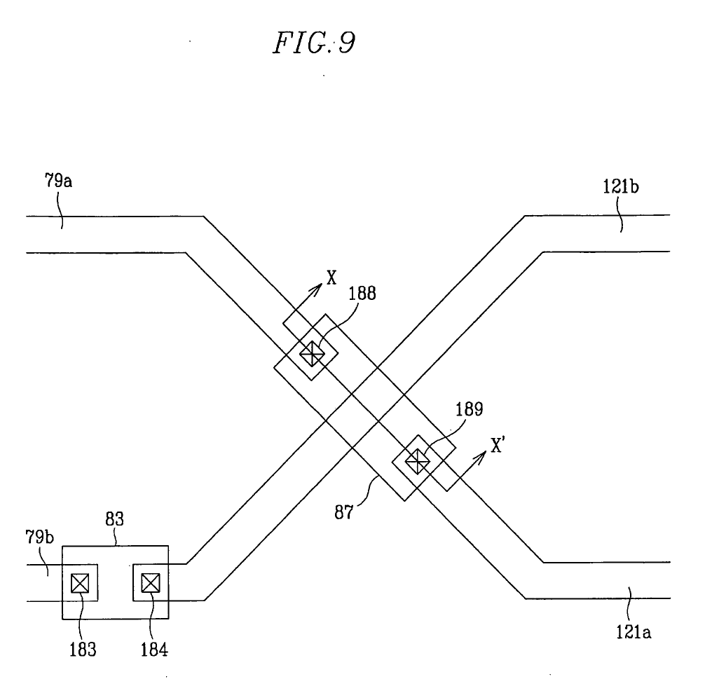

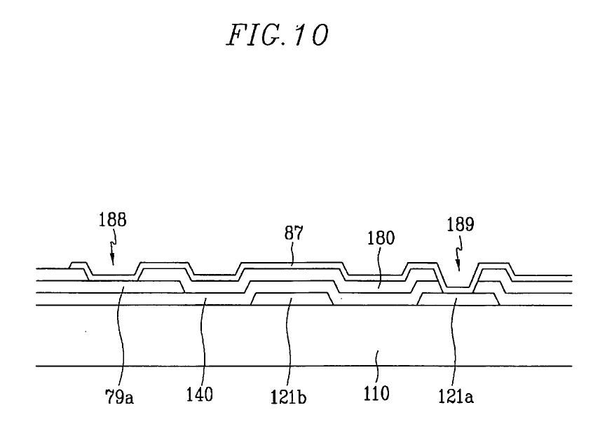

FIG. 7 is a diagram of a TFT panel array for a display device, FIG. 8 is a cross-sectional view of the TFT array panel taken along line 7-7 of FIG. 7, FIG. 9 is a layout view of the gate line in FIG. 3, and FIG. 10 is a cross-sectional view taken along line 9-9 in FIG. 9.

As shown in FIGS. 7 and 8, gate lines 121a and 121b are formed on an insulating substrate 110. The gate lines 121a and 121b deliver gate signals and are formed toward the gate driving portions 400 (FIG. 1) in a horizontal direction. Some portions of the gate lines 121a and 121b become gate electrodes 124 and other portions of the gate lines 121a and 121b become projected portions 127 projected in a downward direction perpendicular to the gate lines 121a and 121b. Further, another portion of the gate lines 121a and 121b are formed in an oblique direction and intersect each other, and another portion of the gate lines 121a and 121b are formed in parallel without intersecting each other.

The gate lines 121a and 121b have a conductive layer including a silver-based metal, for example, low resistivity of silver (Ag), silver alloy, an aluminum-based metal, for example, aluminum (Al) or aluminum alloy, and a copper-based metal, for example, copper or copper alloy. Further, the gate lines 121a and 121b may have a multi-layered structure further including other conductive layers having Cr, Ti, Ta, Mo, including alloys thereof. For example, MoW alloy, with good physical, chemical, and electrical contact with an ITO or IZO is contemplated, but is not limited thereto. A two-layered structure of the upper and lower layers may be, for example, Cr/Al—Nd alloy. Sides defining the gate lines 121a and 121b are inclined with respect to the surface defining the insulating substrate 110. The inclined angle is between about 30° and about 80° relative to the surface defining the insulating substrate 110.

The gate insulating layer 140, fabricated of SiNx, for example, but is not limited thereto, is formed on the gate lines 121a and 121b. The stripe-shaped semiconductors 151 including hydrogenated amorphous silicon (hereinafter, referred to as “a-Si”) are formed on the gate insulating layer 140. The stripe-shaped semiconductors 151 are formed in the vertical direction, as illustrated in FIG. 8, and have first extended portions 154 formed to extend toward the gate electrodes 124. The first extended portions 154 have an increased surface area at a position corresponding to meeting with the gate lines 121. Stripe-shaped and island-shaped ohmic contact members 161 and 165, which include n+ a-Si, for example, but is not limited thereto, with silicide or n-type impurity highly doped, are formed on the stripe-shaped semiconductor 151. The stripe-shaped ohmic contact member 161 has a second extended portion 163. The second extended portion 163 and the island-shaped ohmic contact member 165 are formed on the first extended portion 154. Further, sides defining the stripe-shaped semiconductor 151, and the stripe-shaped and island-shaped ohmic contact members 161 and 165 are inclined, as illustrated in FIG. 8. The inclined angle is between about 30° to and about 80° relative to the surface defining the insulating substrate 110.

Referring to FIG. 7, data lines 171 and output electrodes 175 are formed on the stripe-shaped and island-shaped ohmic contact members 161 and 165, respectively, and storage capacitor 177 and output signal lines 79a and 79b are formed on the gate insulating layer 140. The date lines 171 are formed in a direction perpendicular to the gate lines 121 and deliver data voltages. Input electrodes 173 are formed to extend toward the output electrodes 175 from the date lines 171. The input and output electrodes 173 and 175, respectively, are apart from each other and are opposite with respect to the gate electrodes 124.

As shown in FIG. 9, the output signal lines 79a and 79b extend from the transistors MA14 and MB14 in the gate driving portion 400. The output signal line 79a has an inclined structure defining an end portion thereof.

Referring again to FIG. 8, the gate electrodes 124 and the input and output electrodes 173 and 175, respectively, become TFTs along with the first extended portions 154, and the channel areas of the TFT are formed in the first extended portions 154 between the input and output electrodes 173 and 175, respectively. The storage capacitors 177 overlap the projected portions 127.

The data lines 171, the output electrodes 175, the output signal lines 79a and 79b, and the storage capacitors 177 include a conductive layer having a silver-based metal, (e.g., a low resistivity of silver (Ag) or silver alloy), an aluminum-based metal, (e.g., aluminum (Al) or aluminum alloy), and a copper-based metal, (e.g., copper or copper alloy), for example, but is not limited thereto. Further, the data lines 171, the output electrodes 175, the output signal lines 79a and 79b, and the storage capacitor 177 optionally include a multi-layered structure further having other conductive layers including Cr, Ti, Ta, Mo, and their alloys, including, MoW alloy, for example, but is not limited thereto, with good physical, chemical, electrical contact with an ITO or IZO. Sides of the data lines 171, the output electrodes 175, the output signal lines 79a and 79b, and the storage capacitor 177 are also inclined with respect to the surface of the insulating substrate 110 having inclined angle between about 30° and about 80°.

The stripe-shaped and island-shaped ohmic contact members 161 and 165 are disposed between the stripe-shaped semiconductors 151, and the data lines 171 and the output electrodes 175. The stripe-shaped and island-shaped ohmic contact members 161 and 165, respectively, reduce the contact resistance.

A passivation layer 180 including an organic material having good characteristics and photosensitivity, an insulating material having a low dielectric less than 4.0, (e.g., a-Si:C:O or a-Si:O:F), for example, formed by a PECVD method, or an inorganic material having SiN, for example, is formed on the data lines 171, the output electrodes 175, the output signal lines 79a and 79b, the storage capacitors 177, and the exposed portion of the stripe-shaped semiconductors 151. However, the passivation layer 180 is optionally formed with a two-layered structure of the organic material and SiN. Contact holes 182, 185, 187, 188 and 183, which expose the end portions of the data lines 171, the output electrodes 175, and the end portions of the storage capacitors 177, respectively, are formed on the passivation layer 180. Further, contact holes 189 and 184, which expose the end portions of the gate lines 121a and 121b along with the gate insulating layers 140, respectfully, are formed on the passivation layer 180.

Pixel electrodes 190, contact assistance members 82, and connection assistance members 83 and 87 are formed on the passivation layer 180. The pixel electrodes 190 are physically and electrically connected to the output electrodes 175 and the storage capacitors 177, respectively via the contact holes 185 and 187. The pixel electrodes 190 receive image data voltages from the output electrodes 175 and deliver the image data voltages to the storage capacitors 177.

Referring back to FIG. 2, an electric field is generated between the pixel electrodes 190 receiving the image data voltages and the common electrode 270 formed on the upper substrate 200 receiving the common voltage. Thus, a liquid molecular structure of the liquid crystal layer 3 disposed between the pixel and common electrodes 190 and 270, respectively, is rearranged by the electric field.

As described the above, the pixel electrodes 190 and the common electrode 270 become capacitors, and thus the LC capacitors maintain the image data voltages even after the TFTs are turned off. Further, storage electrodes Cst are formed parallel with the LC capacitor for enhancing charging performance. Referring again to FIG. 8, the storage electrodes Cst are formed in a manner that the pixel electrodes 190 overlap the adjacent gate lines 121. Additionally, the projected portions 127 projecting in a downward direction perpendicular the gate lines 121 increase the capacitance by increasing the overlapped area between the gate lines 121 and the storage electrode Cst. The storage capacitors 177, which are connected to the pixel electrodes 190 and overlap the projected portions 127, are formed under the passivation layer 180 narrowing a gap between the storage capacitors 177 and the passivation layer 180.

The pixel electrodes 190 overlap the adjacent gate lines 121 and the data lines 171, and thus may increase the aperture ratio of the TFT array panel. However, it should be noted that the pixel electrodes 190 may not overlap the adjacent gate lines 121 and the data lines 171.

Referring to FIGS. 7-10, contact assistance members 82 are connected to the ends of the data lines via the contact holes 182. The contact assistance members 82 may improve the feature of affixing the ends of the data lines 171 to an external device and protect these elements. Connecting assistance members 83 and 87 are physically and electrically connected to the output signal lines 79a and the gate lines 121a, and the output signal lines 79b and the gate lines 121b via the contact holes 188 and 189, and the contact holes 183 and 184, respectively. The connecting assistance members 83 and 87 receive the gate voltages from the output signal lines 79a and 79b and deliver the gate voltages to the gate lines 121a and 121b, respectively. In this manner, two gate lines may be intersected. However, it should be noted that two or more gate lines may be intersected. As shown in FIG. 9, the output signal line 79a is connected to the gate line 121a by forming the contact holes 188 and 189 at the ends of the output signal line 79a and the gate line 121a, respectively, and using the connecting assistance member 87. However, the output signal line 79a may overlap the gate line 121a and be connected to the gate line 121a using the contact holes 188 and 189 formed on the overlapped portions.

According to the exemplary embodiments disclosed herein, the pixel electrodes 190 are made of a transparent conductive polymer, for example, and in a reflective LCD, the pixel electrodes 190 may be made of a non-transparent reflective metal. The contact assistance members 82 are optionally made of a different material including ITO or IZO, for example.

As described above, each stage may reduce the total surface area by sharing the transistor T1 of the output portions 450 (FIG. 4) occupying the largest area. Accordingly, the exemplary embodiments disclosed herein increase a margin of the design and provide a high resolution of a display device. Further, the exemplary embodiments disclosed herein allowing an increase in output performance and improved performance of the gate driving portions.

Having described the embodiments of the present invention and its advantages, it should be noted that various changes, substitutions and alterations can be made herein without departing from the spirit and scope of the invention as defined by the appended claims.

1. A gate driving portion having a plurality of stages, each stage comprising:
a first driving portion, the first driving portion generates a first and second output signal according to first input signals, and
a second driving portion connected to the first driving portion through a first clock signal terminal, the second driving portion generates a third and fourth output signals according to second input signals,
wherein the first and second input signals include at least one of a plurality of output signals of adjacent stages, a second clock signal and at least one low-level signal, and
the first, second, third, and fourth output signals include at least one of a plurality of gate output signals and a plurality of carry output signals.

2. The gate driving portion of claim 1, wherein the first and second clock signals have about a 180° phase difference.

3. The gate driving portion of claim 1, wherein the at least one low-level signal is a Voff voltage and a reset voltage.

4. The gate driving portion of claim 1, wherein the first driving portion generates gate output signals of odd gate lines and the second driving portion generates gate output signals of even gate lines.

5. The gate driving portion of claim 1, wherein the first input signals in a first stage of the plurality of stages further include a vertical synchronization start signal.

6. The gate driving portion of claim 4, wherein the first and second driving portions each includes:
an input portion, the input portion receives the first and second clock signals, the low-level voltage, and a carry output signal of a following stage, the carry output signal of the following stage generates first control signals;
a pull-down driving portion connected to the input portion, the pull-down driving portion generates second control signals according to the first control signals from the input portion, the low-level voltage, a reset signal, and the gate output signal of the following stage;
a pull-up driving portion connected to the input portion and the pull-down driving portion, the pull-up driving portion generates third control signals according to the first and second control signals, a carry output signal of the following stage, and the first clock signal; and
an output portion connected to the input portion and the pull-down and pull-up driving portions, the output portion generates the first and second output signals according to the first clock signal and the first, second, and third control signals.

7. The gate driving portion of claim 6, wherein the first and second driving portions have a mirror symmetric structure with respect to the first clock terminal.

8. The gate driving portion of claim 7, wherein the input portion comprises:
a first switching element;
a second switching element having a second gate; and
a third switching element having a third gate;
wherein the second and third gates of the second and third switching elements, respectively, are connected to the second clock signal,
the second gate of the second switching element is connected to the first clock signal, and
the first and second switching elements are connected to the carry output signal of a previous stage and the low-level voltage, respectively.

9. The gate driving portion of claim 8, wherein the pull-up driving portion comprises:
a fifth switching element having a fifth gate and a fifth source connected to the carry output signal of the previous stage and a fifth drain connected to a first contact point;
a sixth switching element having a sixth gate connected to the carry output signal of the following stage, a sixth drain connected to the first contact point, and a sixth source connected to the pull-down driving portion and the output portion;
an eighth switching element having an eighth gate and an eighth source connected to the first clock signal and an eighth drain connected to a third contact point and the pull-down driving portion; and
a ninth switching element having a ninth gate and a ninth source connected to a sixth contact point through a second capacitor, and the ninth gate and a ninth drain connected to a fourth contact point through a third capacitor,
wherein the drain of the eighth switching element is connected to the ninth gate of the ninth switching element.

10. The gate driving portion of claim 9, wherein the pull-down driving portion comprises:
a fourth switching element having a fourth gate connected to the reset signal, a fourth source connected to the carry output signal of the previous stage, and a fourth drain connected to the low-level voltage;
a seventh switching element having a seventh gate connected to the gate output signal of the following stage, a seventh drain connected to the low-level voltage, and a seventh source connected to a fifth contact point;
a tenth switching element having a tenth gate connected to a second contact point, a tenth drain connected to the low-level voltage, and a tenth source connected to the third contact point;
an eleventh switching element having an eleventh gate connected to the second contact point, an eleventh drain connected to the low-level voltage, and an eleventh source connected to the fourth contact point;
a twelfth switching element having a twelfth gate connected to the fourth contact point, a twelfth drain connected to the low-level voltage, and a twelfth source connected to the second contact point;
a thirteenth switching element having a thirteenth gate connected to the gate output signal of the following stage, a thirteenth drain connected to the low-level voltage, and a thirteenth source connected to the second contact point; and
a sixteenth switching element having a sixteenth gate connected to the gate output signal of the following stage, a sixteenth drain connected to the low-level voltage, and a sixteenth source connected to the output portion.

11. The gate driving portion of claim 10, wherein the output portion comprises:
a fourteenth switching element having a fourteenth gate connected to the fifth contact point, a fourteenth drain connected to the second contact point, and a fourteenth source connected to a first output terminal; and
a fifteenth switching element having a fifteenth gate connected to the fourteenth gate of the fourteenth switching element and the fifth contact point, a fifteenth drain connected to a second output terminal, and a fifteenth source connected to the first clock signal.

12. The gate driving portion of claim 11, wherein the second driving portion further comprises:
an output assistance portion, the output assistance portion generates fourth control signals according to the third control signals and the first clock signal and controls the output portions of the first and second driving portions; and
the pull-down driving portion that includes a seventeenth switching element having a seventeenth gate connected to the gate output signal of the following stage, a seventeenth drain connected to the fifth contact point, and a seventeenth source connected to the low-level voltage, and an eighteenth switching element having an eighteenth gate connected to the gate output signal of the following stage, an eighteenth drain connected to the second contact point, and an eighteenth source connected to the low-level voltage.

13. The gate driving portion of claim 12, wherein the output assistance portion comprises:
a nineteenth switching element having a nineteenth gate connected to the first contact point, a nineteenth drain connected to the second contact point and the output portion of the second driving portion, the nineteenth gate and nineteenth drain connected to each other through a first capacitor, and a nineteenth source connected to the first clock signal.

14. The gate driving portion of claim 13, wherein the first contact point maintains a high voltage during 4 H.

15. The gate driving portion of claim 14, wherein the fifth contact point maintains a high voltage during 2 H.

16. The gate driving portion of claim 14, wherein the fifth contact point of the second driving portion changes a low voltage into a high voltage when the gate output signal of the following stage is generated and maintains the high voltage during 2 H.

17. The gate driving portion of claim 16, wherein the reset signal is generated at a dummy stage after about half of stages and is inputted to all of the plurality of stages.

18. The gate driving portion of claim 16, wherein the first capacitor has a voltage higher than a high voltage.

19. The gate driving portion of claim 13, wherein the first to nineteenth switching elements are made of amorphous silicon.

20. The gate driving portion of claim 19, wherein the first to nineteenth switching elements are formed by a substantially same manufacturing process as switching elements of a pixel area.

21. A gate driving portion having a plurality of stages, each stage comprising:
a first gate line having
a first connecting member;
a first insulating layer formed on the first connecting member;
a first conductive layer formed on the first insulating layer;
a second insulating layer formed on the first insulating layer and the first conductive layer; and
a first connecting assistance member connected to the first conductive layer and the first connecting member, and
a second gate line having
a second connecting member disposed between the first connecting member and the first conductive layer;
the first insulating layer formed on the second connecting member;
a second conductive layer formed on the first insulating layer;
the second insulting layer formed on the first insulating layer and the second conductive layer; and
a second connecting assistance member connected to the second conductive layer and the second connecting member.

22. A display device, comprising:
a signal controller receiving image data signals and control signals, the signal controller generates gate and data control signals;
a data driving portion, the data driving portion receives the image data signals and the data control signals and converts the image data signals into image data voltages according to the data control signals;
a gate driving portion, the gate driving portion generates gate output signals turning on or turning off a plurality of switching elements according to the gate control signals; and
a TFT array panel having data lines, gate lines, switching elements, and pixel circuits on an insulating substrate,
wherein the gate driving portion is formed on the insulating substrate and includes stages corresponding to the gate lines, each stage generates two or more gate output signals.
